(19) United States
(12) Patent Application Publication
(10) Pub. No.: US 2009/0296304 A1
(43) Pub. Date: Dec. 3, 2009

(54) Switch

(75) Inventor: Kazuhiko Kagawa, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI ELECTRIC CORPORATION, Chiyoda-ku (JP)

(21) Appl. No.: 12/201,686

(22) Filed: Aug. 29, 2008

(30) Foreign Application Priority Data
May 27, 2008 (JP) 2008-138101

(51) Int. Cl. H01H 47/00

(52) U.S. Cl. 361/170

(57) ABSTRACT

A switch is obtained in which whether the counting of the number of operations is performed in accordance with an on-operation counting method or an off-operation counting method can readily be selected and changed, and an operation check can readily be performed. The switch is provided with a main contact; an operation mechanism that on/off-operates the main contact; an on-operation circuit that is configured with a first relay contact, an on-operation coil, and a first auxiliary contact that are connected in series, and drives the operation mechanism in accordance with an on-command from outside so that the main contact performs an on-operation; an off-operation circuit that is configured with a second relay contact, an off-operation coil, and a second auxiliary contact that are connected in series, and drives the operation mechanism in accordance with an off-command from outside so that the main contact performs an off-operation; and a counter that is electrically connected to the on-operation circuit or the off-operation circuit and counts the number of operations of the operation mechanism, in conjunction with the operation of the circuit to which the counter is connected.

### BACKGROUND OF THE INVENTION

1. Field of the Invention

The present invention relates to an electric-power switch in which a main contact is operated through an operation mechanism, and there is provided a counter that counts and displays the number of operations of the operation mechanism.

2. Description of the Related Art

As a technology for counting and displaying the number of operations of a switch, for example, there have been disclosed technologies in which, in a switch where a drive spring is driven by rotation force of a motor, a main shaft is driven at high speed through compression and restoration of a driving spring, and there is provided an operation device that operates an electric spring to open and close a switching body coupled with the main shaft, a counter mechanically coupled with the main shaft is provided in the operation device, and the counter is operated in conjunction with pivoting of the main shaft (e.g., refer to Japanese Patent Laid-Open Pub. No. 1993-81957, p2, FIG. 1).

In the case of an operation counter for such a conventional switch as disclosed in Japanese Patent Laid-Open Pub. No. 1993-81957, respective levers provided on an operation device and on a main shaft are mechanically coupled so that the number of operations is counted in response to any one of the on-operation or off-operation of the switch. Accordingly, it has been difficult to make a change between on-operation counting and off-operation counting.

Additionally, due to restriction on the arrangement of the driving portions for coupling structures and other constituent components of other operation mechanisms, the counter is disposed in a position that is relatively close to the driving portion of the operation device; therefore, in order to read the number of operations, it has been required for an operator to approach the switch so as to check the readout. In many cases, a switch of this kind is contained in a switchgear or the like and operated unaccompanied; therefore, there has been a problem that, in order to check the number of operations, it is required for an operator to visit the installation place of the switchgear.

### SUMMARY OF THE INVENTION

The present invention has been implemented in order to solve the foregoing problems; the objective thereof is to obtain a switch in which whether the counting of the number of operations is performed in accordance with an on-operation counting method or an off-operation counting method can readily be selected and changed, and an operation check can readily be performed.

A switch according to the present invention is provided with a main contact of the switch; an operation mechanism that on/off-operates the main contact; an on-operation circuit that is configured with a first relay contact, an on-operation coil, and a first auxiliary contact that are connected in series, and drives the operation mechanism in accordance with an on-command from outside so that the main contact performs an on-operation; an off-operation circuit that is configured with a second relay contact, an off-operation coil, and a second auxiliary contact that are connected in series, and drives the operation mechanism in accordance with an off-command from outside so that the main contact performs an off-operation; and an electromagnetic or electronic counter that is electrically connected to the on-operation circuit or the off-operation circuit and counts the number of operations of the operation mechanism, in conjunction with the operation of the operation circuit to which the counter is connected.

According to the present invention, provision is made for an on-operation circuit that makes the main contact perform an on-operation, in response to an on-command from outside; an off-operation circuit that makes the main contact perform an off-operation, in response to an off-command from outside; and a counter that is electrically connected to any one of the operation circuits and counts the number of operations of the operation mechanism, in conjunction with the operation of the operation circuit to which the counter is connected. Therefore, whether the counting of the number of operations is performed in accordance with an on-operation counting method or an off-operation counting method can readily be selected and changed. Moreover, the installation place of the counter can freely be selected; thus, a switch in which the number of operations is readily checked can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an operation circuit unit of a switch according to Embodiment 1 of the present invention;

FIG. 2 is a block diagram illustrating another example of an operation circuit unit of a switch according to Embodiment 1; and

FIG. 3 is a block diagram illustrating an operation circuit unit of a switch according to Embodiment 2.

### DETAILED DESCRIPTION OF THE INVENTION

### Embodiment 1

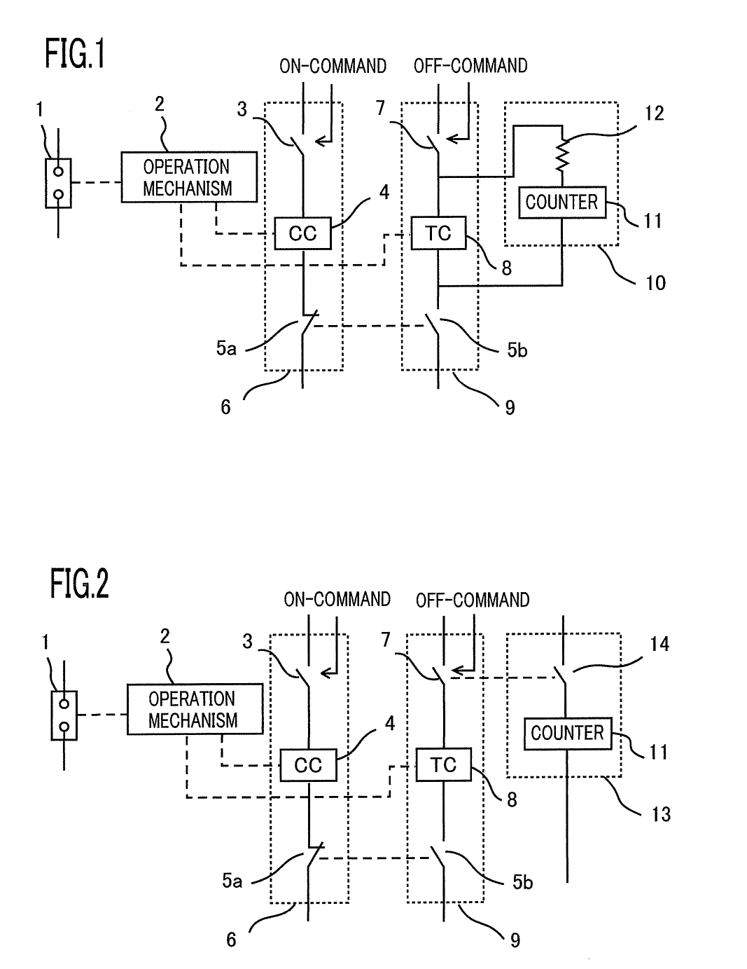

FIG. 1 is a diagram illustrating the configuration of an operation circuit unit of a switch according to Embodiment 1 of the present invention.

In FIG. 1, in the case of, for example, a vacuum circuit breaker, a main contact 1 of a switch is a vacuum interrupter that forms the circuit breaking unit of the vacuum circuit breaker. The vacuum interrupter is contained in a vacuum container in such a way that the fixed contact and the moving contact thereof are detachable from and attachable to each other.

Provision is made for an operation mechanism 2 that makes the main contact 1 on/off-operate, via a link (unillustrated). As the operation mechanism 2, for example, an electric-spring-driving operation mechanism that utilizes the compression force exerted on a drive spring or an electromagnet-driving operation mechanism is adopted.

An operation circuit that makes the operation mechanism 2 operate in response to an on-command or an off-command from outside is provided with an on-operation circuit 6 that is configured with a first relay contact 3, an on-operation coil 4, and a first auxiliary contact 5a that are connected in series, and drives the operation mechanism 2 in accordance with the on-command so that the main contact 1 performs an on-operation; and an off-operation circuit 9 that is configured with a second relay contact 7, an off-operation coil 8, and a second auxiliary contact 5b that are connected in series, and drives the operation mechanism 2 in accordance with the off-command so that the main contact 1 performs an off-operation.

The first auxiliary contact 5a is a b-contact, and the second auxiliary contact 5b is an a-contact. The auxiliary contacts 5a and 5b operate in conjunction with each other.

A counter unit 10 is connected in parallel with the off-operation coil 8 in the off-operation circuit 9. The counter unit 10 is provided with an electromagnetic or electronic counter 11 and a resistor 12 that is connected in series to the counter 11 and adjusts the difference between the operational voltages of the off-operation coil 8 and the counter 11.

Next, the operation of the operation circuit unit will be explained.

In the first place, the on-operation of the main contact 1 of the switch will be explained. When the on-command from outside is inputted to the first relay contact 3 and thereby the first relay contact 3 is closed, a current flows in the circuit because the first auxiliary contact 5a is closed, whereby the on-operation coil 4 is energized, so that the operation mechanism 2 operates to close the main contact 1. When the main contact 1 is closed, the first auxiliary contact 5a is opened, and in conjunction with the operation of the first auxiliary contact 5a, the second auxiliary contact 5b is closed.

In contrast, in the case of the off-operation of the main contact 1, when the off-command from outside is inputted to the second relay contact 7 and thereby the second relay contact 7 is closed, a current flows in the circuit because the second auxiliary contact 5b is closed, whereby the off-operation coil 8 is energized, so that the operation mechanism 2 operates to open the main contact 1. When the main contact 1 is opened, the second auxiliary contact 5b is opened.

When, through the off-command, the second relay contact 7 is closed and thereby a current flows in the off-operation coil 8, a current flows also in the counter unit 10, whereby, in conjunction with the off-operation of the main contact 1, the counter 11 can count the number of off-operations of the operation mechanism 2.

Because being connected to the off-operation circuit 9 by means of lead wires, the counter unit 10 is not required to be disposed in the vicinity of the operation mechanism 2, whereby the position thereof can freely be selected.

In addition, FIG. 1 illustrates a case where the counter unit 10 is connected to the off-operation circuit 9; however, also in the case where the number of on-operations of the operation mechanism 2 is counted, a similar operation is performed by connecting the counter unit 10 in parallel with the on-operation circuit 6. The change of the operation circuit can readily be implemented only by changing the wiring.

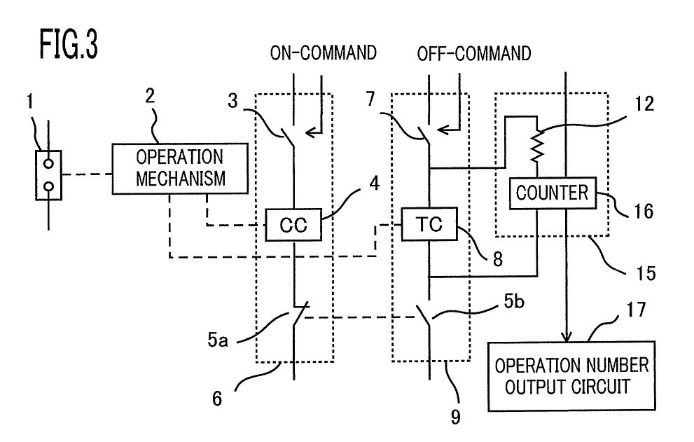

In FIG. 1 explained above, the counter unit 10 is configured with the counter 11 and the resistor 12 that are connected in series; another configuration example of the counter is illustrated in FIG. 2. Because the circuit units other than the counter unit are the same as those in FIG. 1, the same constituent elements are designated by the same reference characters, explanations therefor are omitted, and the difference between FIG. 1 and FIG. 2 will mainly be explained.

A counter unit 13 in a switch illustrated in FIG. 2 is configured with the counter 11 and a relay contact 14 connected in series to the counter 11; the relay contact 14 operates in synchronization with the second relay contact 7.

With such a configuration as described above, in the case where the main contact 1 of the switch is opened, when the off-command is inputted and the second relay contact 7 is closed, the relay contact 14 coupled with the relay contact 7 is closed at the same time, the counter 11 operates, and then the number of off-operations of the operation mechanism 2 can be counted.

In this example, the counter unit 13 is not required to be disposed close to the off-operation circuit 9. The counter 13 can be disposed in a place where the number of operations is readily checked, for example, in an integrated control apparatus for performing a remote on/off-command operation, in the case where the switch is disposed in an unaccompanied facility; therefore, the number of operations can remotely and readily be checked.

In addition, FIG. 2 illustrates a case where the counter unit 13 is connected to the off-operation circuit 9; however, as is the case with FIG. 1, in the case where the number of on-operations of the operation mechanism 2 is counted, the counter unit 13 may be connected to the on-operation circuit 6.

As described above, according to Embodiment 1, provision is made for the main contact; the operation mechanism that on/off-operates the main contact; the on-operation circuit that is configured with the first relay contact, the on-operation coil, and the first auxiliary contact that are connected in series, and drives the operation mechanism in accordance with the on-command from outside so that the main contact performs an on-operation; the off-operation circuit that is configured with the second relay contact, the off-operation coil, and the second auxiliary contact that are connected in series, and drives the operation mechanism in accordance with the off-command from outside so that the main contact performs an off-operation; and the electromagnetic or electronic counter that is electrically connected to the on-operation circuit or the off-operation circuit and counts the number of operations of the operation mechanism, in conjunction with the operation of the operation circuit to which the counter is connected. Therefore, whether the counting of the number of operations is performed in accordance with an on-operation counting method or an off-operation counting method can readily be selected and changed. Moreover, as the installation place of the counter, a place where the number of operation can readily be checked (e.g., the door face of a switchgear that contains a switch or an integrated control apparatus apart from the switch) can freely be selected; therefore, a switch in which the number of operations is readily checked can be obtained.

### Embodiment 2

FIG. 3 is a block diagram illustrating an operation circuit unit of a switch according to Embodiment 2. The constituent elements the same as those in FIG. 1 are designated by the same reference characters, explanations therefor are omitted, and the difference between FIG. 1 and FIG. 3 will mainly be explained.

In Embodiment 2, a counter unit 15 is connected in parallel with the off-operation coil 8. The counter unit 15 is configured with an electronic counter 16 and the resistor 12 connected in series to the counter 16. The counter 16 has a reaching information transmitting function in which a signal is generated, when a predetermined number is reached, or by operating a contact. Additionally, the counter 16 has an operation number outputting circuit 17 that outputs the reaching information outside.

The counter 16 is what is well known as a programmable counter and commercially available; therefore, such a programmable counter may be utilized.

The operation of the counter 16 will be explained. When the number of operations of the operation mechanism 2 reaches a number preliminarily set in the counter 16, the counter 16 generates a signal (or a contact provided inside the counter 16 operates). The reaching information is outputted outside through the operation number outputting circuit 17.

In addition, FIG. 3 illustrates a case where the counter unit 15 is connected to the off-operation circuit 9; however, in the case where the number of on-operations of the operation mechanism 2 is counted, a similar operation is performed by connecting the counter unit 15 to the on-operation circuit 6.

As described above, in Embodiment 2, the counter has a function of transmitting reaching information when the number of operations reaches a preset number, and provision is made for an output circuit that conveys the transmitted reaching information outside; therefore, in addition to the effect of Embodiment 1, by ascertaining that the number of operations has reached a preset number, for example, wear and tear on the mechanical parts of an operation mechanism and the level of wear and deterioration of a main contact are estimated, so that the inspection timing and the like can readily be grasped.

While the presently preferred embodiments of the present invention have been shown and described. It is to be understood that these disclosures are for the purpose of illustration and that various changes and modifications may be made without departing from the scope of the invention as set forth in the appended claims.

What is claimed is:

1. A switch comprising:
a main contact of the switch;
an operation mechanism that on/off-operates the main contact;
an on-operation circuit that is configured with a first relay contact, an on-operation coil, and a first auxiliary contact that are connected in series, and drives the operation mechanism in accordance with an on-command from outside so that the main contact performs an on-operation;
an off-operation circuit that is configured with a second relay contact, an off-operation coil, and a second auxiliary contact that are connected in series, and drives the operation mechanism in accordance with an off-command from outside so that the main contact performs an off-operation; and
an electromagnetic or electronic counter that is electrically connected to the on-operation circuit or the off-operation circuit and counts the number of operations of the operation mechanism, in conjunction with the operation of the on-operation circuit or the off-operation circuit to which the counter is connected.

2. The switch according to claim 1, wherein the counter has a function of transmitting reaching information when the number of operations reaches a preliminarily set number, and provision is made for an output circuit that conveys the transmitted reaching information outside.
